(19) United States
(12) Patent Application Publication
(10) Pub. No.: US 2011/0097970 A1
(43) Pub. Date: Apr. 28, 2011

(54) Sound Generating Apparatus for Attracting Wild Game

(76) Inventor: Richard A. Wyant, Red Hook, NY (US)

(21) Appl. No.: 12/606,406

(22) Filed: Oct. 27, 2009

(51) Int. Cl. A01M 31/00; A63H 5/00

(52) U.S. Cl. 446/418

(57) ABSTRACT

An apparatus for generating sounds comprises a pair of end blocks, a pair of opposing sidewalls, an upper actuator, and a lower actuator. The pair of end blocks is disposed at opposite ends of the apparatus. The pair of opposing sidewalls, in turn, is attached to the pair of end blocks, and each of the pair of opposing sidewalls has a respective top edge and a respective bottom edge. The upper actuator pivotally mounts on one of the pair of end blocks such that pivoting the upper actuator causes it to scrape against the top edges of the pair of opposing sidewalls. Likewise, the lower actuator is pivotally mounted on one of the pair of end blocks such that pivoting the lower actuator causes it to scrape against the bottom edges of the pair of opposing sidewalls. The apparatus is operative to make sounds that mimic those produced by wild game such as wild turkeys.

### FIELD OF THE INVENTION

The present invention relates generally to apparatus for generating sounds while hunting or observing wild animals, and, more particularly, to box calls for attracting game such as wild turkeys.

### BACKGROUND OF THE INVENTION

A box call is a common tool for use while hunting wild turkeys. Typically a box call comprises an open-topped, elongate wooden box. A wooden actuator top is pivotally attached to an end of this wooden box in such a manner that a bottom surface of the actuator top can be made to scrape against the sidewalls of the box. Scraping the wooden actuator top in this manner causes the box call to produce sounds that are similar to those produced by wild turkeys. Box calls can vary from inexpensive, mass-produced goods to elaborately decorated, rare, and expensive collectables.

Wild turkeys typically have many vocalizations including what can be described as “gobbles,” “clucks,” “putts,” “purrs,” “yelps,” “cutts,” “whines,” “cackles,” and “kee-kees.” A skilled user can simulate several of these sounds with a box call. Nevertheless, wild turkeys are typically very cautious and observant animals. As a result, they may respond very differently to even minor variations in sounds. The present inventor has personally observed, for example, that wild turkeys may be strongly attracted to one particular sound and be uninterested or even made more guarded by a minor variation on that sound. Unfortunately, the sounds produced by a given box call largely depend on the type of woods employed in its construction and the shape of the sound chamber formed by the wooden box. As a result, the sounds produced by conventional box calls are largely fixed at the time of manufacture and cannot be varied to any great degree in the field.

For the foregoing reasons, there is a need for box calls that can readily produce several variations of sounds. With this added capability, a hunter may sample the sounds produced by the box call until a variation is found that effectively causes the desired game to move towards the hunter.

### SUMMARY OF THE INVENTION

Embodiments of the present invention address the above-identified need by providing box call apparatus capable of producing a range of different sounds that mimic those generated by game such as wild turkeys.

In accordance with an aspect of the invention, an apparatus for generating sounds comprises a pair of end blocks, a pair of opposing sidewalls, an upper actuator, and a lower actuator. The pair of end blocks is disposed at opposite ends of the apparatus. The pair of opposing sidewalls, in turn, is attached to the pair of end blocks, and each of the pair of opposing sidewalls has a respective top edge and a respective bottom edge. The upper actuator pivotally mounts on one of the pair of end blocks such that pivoting the upper actuator causes it to scrape against the top edges of the pair of opposing sidewalls. Likewise, the lower actuator is pivotally mounted on one of the pair of end blocks such that pivoting the lower actuator causes it to scrape against the bottom edges of the pair of opposing sidewalls.

In accordance with one of the above-identified embodiments of the invention, a box call comprises a pair of end blocks that are disposed at opposite ends of the apparatus. A pair of opposing sidewalls is attached to these end blocks, and each of the pair of opposing sidewalls has a respective top edge and a respective bottom edge. An upper actuator and a lower actuator are pivotally mounted on opposite faces of one of the end blocks. Manually pivoting the upper actuator causes the upper actuator to scrape against the top edges of the opposing sidewalls, while pivoting the lower actuator causes the lower actuator to scrape against the bottom edges of the opposing sidewalls. It is this scraping that is utilized to generate sounds. To allow for additional variations in the generated sounds, a tuning block is also captured between the opposing sidewalls and adapted to be manually translatable along a length of the sidewalls.

In accordance with another one of the above-identified embodiments, the above-described box call is modified to include a tuning slat instead of a tuning block. The tuning slat also occupies the region between the opposing sidewalls but, unlike the tuning block, is manually rotatable about a rotational axis that intersects both end blocks. Pivoting the tuning slat in this manner also causes the box call to produce a variety of different sounds.

Advantageously, these embodiments of the invention and others within the scope of the appended claims allow a user (e.g., hunter) to readily vary the sounds produced by a box call until that user comes upon a sound that effectively attracts wild game.

### BRIEF DESCRIPTION OF THE DRAWINGS

These and other features, aspects, and advantages of the present invention will become better understood with regard to the following description, appended claims, and accompanying drawings where:

FIG. 1A shows a perspective view of a box call in accordance with a first illustrative embodiment of the invention;

FIG. 1B shows an exploded side view of the FIG. 1A box call;

FIG. 1C shows plan view of the FIG. 1A box call;

FIG. 1D shows another plan view of the FIG. 1A box call;

FIG. 1E shows a cross-sectional view of the FIG. 1A box call cut along the plane indicated in FIG. 1C;

FIG. 2A shows a plan view of a box call in accordance with a second illustrative embodiment of the invention;

FIG. 2B shows another plan view of the FIG. 2A box call;

FIG. 2C shows an end-on view of the FIG. 2A box call; and

FIG. 2D shows a cross-sectional view of the FIG. 2A box call cut along the plane indicated in FIG. 2B.

### DETAILED DESCRIPTION OF THE INVENTION

The present invention will be described with reference to illustrative embodiments. For this reason, numerous modifications can be made to these embodiments and the results will still come within the scope of the invention. No limitations with respect to the specific embodiments described herein are intended or should be inferred.

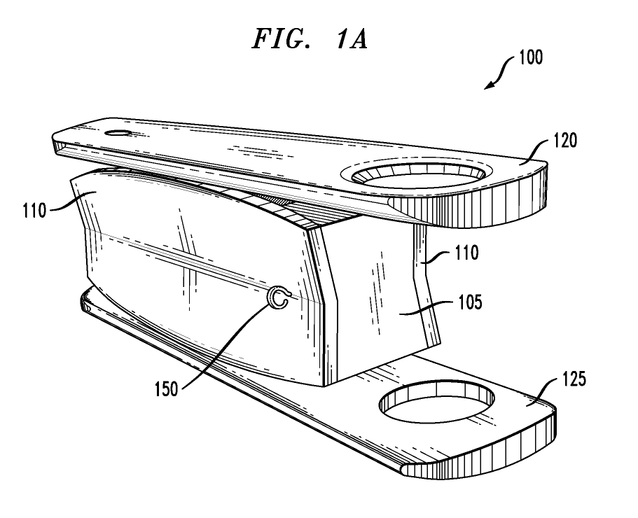

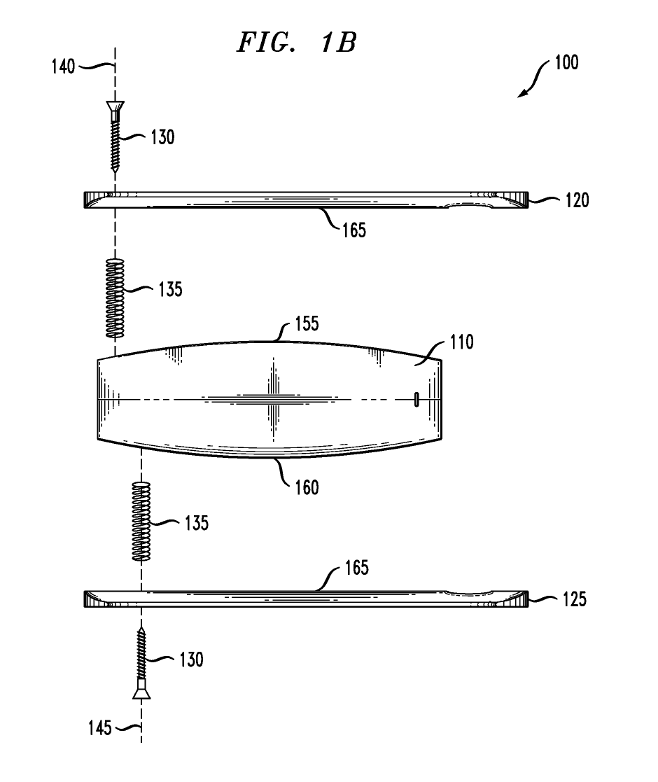

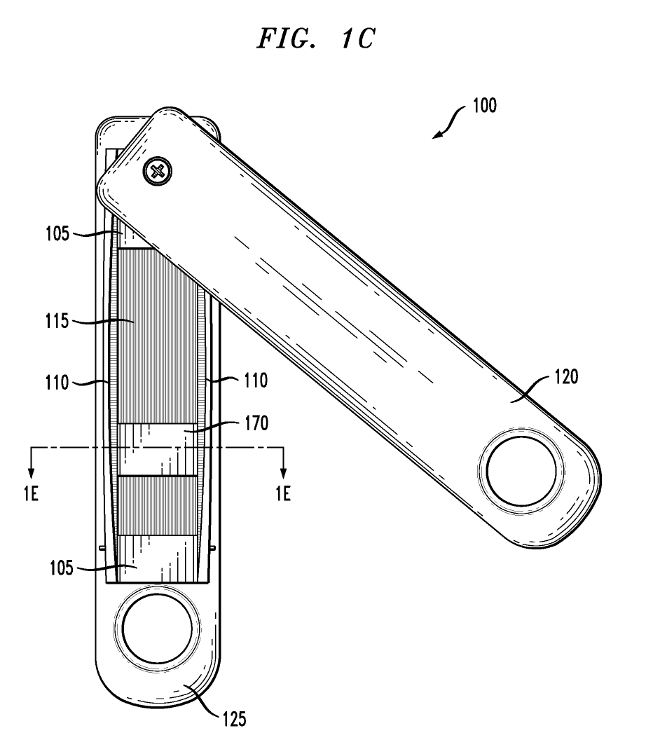

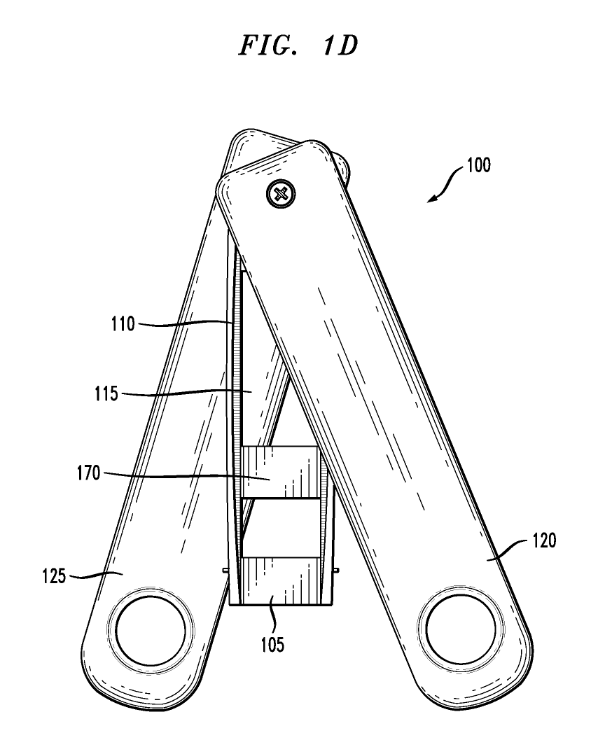

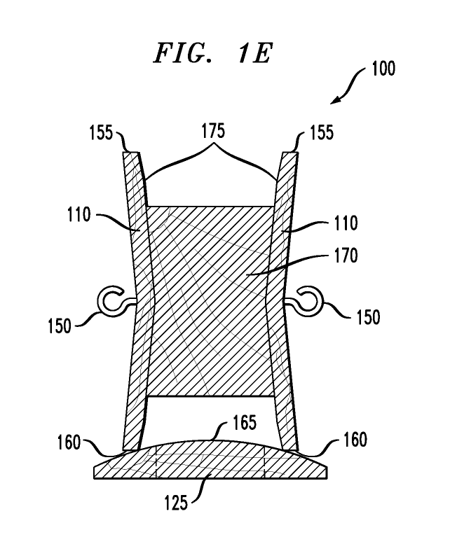

FIGS. 1A-1E show a box call 100 in accordance with a first illustrative embodiment of the invention. FIG. 1A shows a perspective view, FIG. 1B shows an exploded side view, FIGS. 1C and 1D show plan views, and FIG. 1E shows a cross-sectional view cut along the plane indicated in FIG. 1C.

As shown in these figures, the box call 100 comprises a pair of end blocks 105 that are disposed at opposite ends of the apparatus. A pair of opposing sidewalls 110 is attached to these end blocks to define an elongate sound chamber volume 115. An upper actuator 120 and a lower actuator 125 are mounted on opposite faces of one of the end blocks. The actuators are mounted to the end block using screws 130 and springs 135 that allow the actuators to independently pivot about axes of rotation 140 and 145, respectively. Two hooks 150 facilitate the optional use of rubber bands (not shown) to secure the box call during transport.

Each of the pair of opposing sidewalls 110 has a respective curved top edge 155 and a respective curved bottom edge 160. Each of the upper and lower actuators 120, 125, in turn, has a respective convex surface 165 that faces these sidewall edges. Accordingly, manually pivoting the upper actuator about its axis of rotation 140 causes the convex surface of the upper actuator to scrape against the top edges 155 of the opposing sidewalls 110. Pivoting the lower actuator about its axis of rotation 145 causes the convex surface of the lower actuator to scrape against the bottom edges 160 of the opposing sidewalls. It is this scraping that produces the sounds that mimic those produced by wild game such as wild turkeys.

The illustrative box call 100 preferably comprises wood (e.g., maple, walnut, cherry, mahogany, poplar, oak, and basswood), although other suitable materials may also be utilized (e.g., plastic). Natural variations in the wood forming the box call will cause the upper actuator 120 to generate different sounds from the lower actuator 125. Moreover, utilizing different pairings of woods allows the box call to generate even more variations of sounds. The upper actuator may, for example, be formed of a different wood from the lower actuator. The opposing sidewalls 110 may also be formed of different types of wood from each other. Chalk or paint (not shown) may be applied to the convex surfaces 165 of the actuators in order to further modify the sounds generated by the box call and to increase its loudness.

In addition, the sounds produced by a given actuator 120, 125 depend on the positioning of the opposing actuator. The upper actuator 120 will, for example, produce different sounds with the lower actuator 125 positioned as shown in FIG. 1C than it will with the lower actuator positioned as shown in FIG. 1D. What is more, to allow the box call 100 to generate even more variations of sounds, the illustrative box call comprises an additional feature, namely, a tuning block 170. The tuning block is captured between the opposing sidewalls 110 and is operative to be translated by hand without the use of tools (i.e., “manually translated”) along a length of the sidewalls. Moving the tuning block in this manner modifies the sound chamber volume 115, thereby also changing the sounds produced by the box call.

In the present embodiment, the tuning block 170 is captured between the opposing sidewalls 110 by forming each of the opposing sidewalls 110 so that it has an internal sidewall face 175 that comprise two surfaces that meet at an oblique angle (best seen in the FIG. 1A perspective view and the FIG. 1E cross-section). The tuning block, in turn, is manufactured with opposing faces that have surfaces that are substantially inverse in shape to these internal sidewall faces (see FIG. 1E). The tuning block is thereby permanently held between the opposing sidewalls, but is also capable of being manually translated along a portion of the length of the opposing sidewalls in order to vary the sounds generated by the box call 100. A hunter may use this tuning block to readily vary the sounds produced by the box call until the hunter comes upon a sound that effectively moves the sought after game towards the hunter. The hunter is thereby provided with a substantial advantage over conventional box calls.

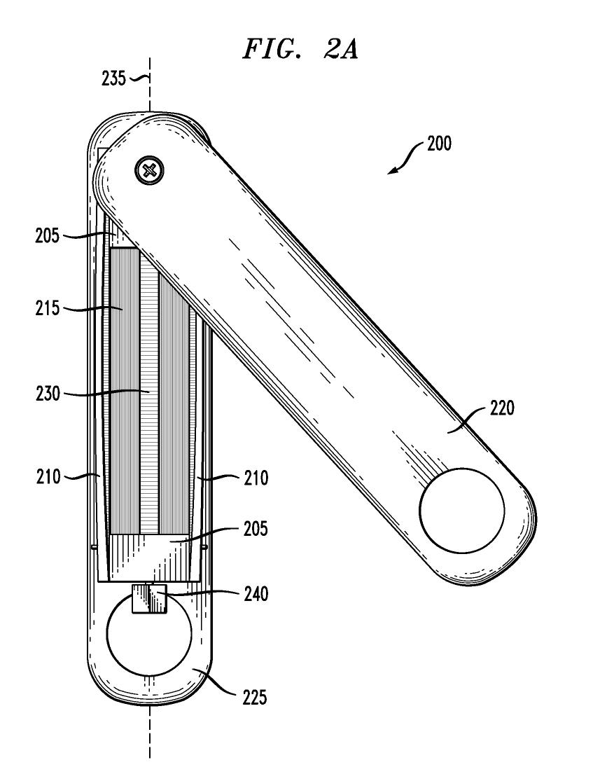

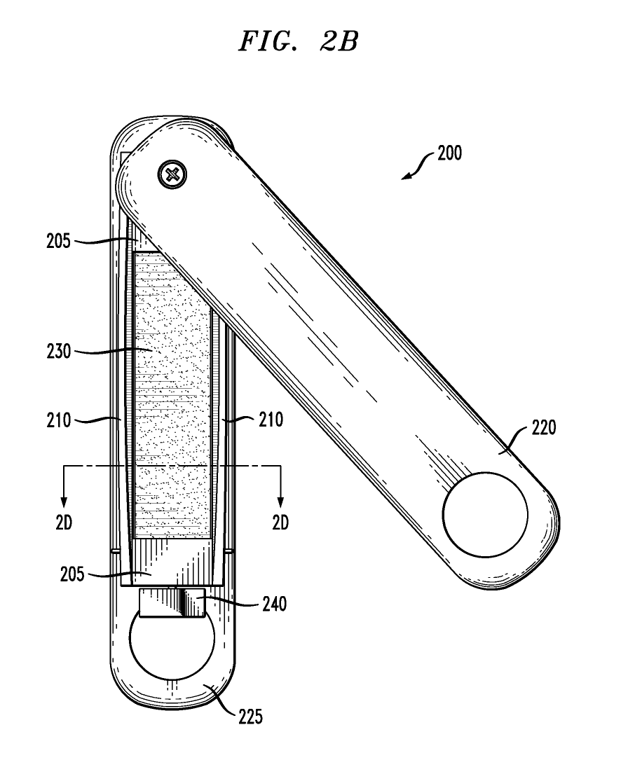

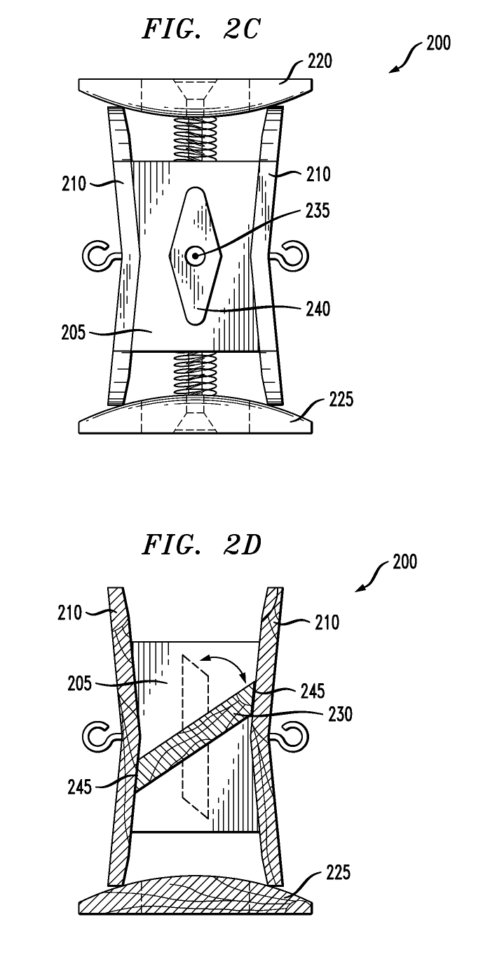

FIGS. 2A-2D show another box call 200, this one in accordance with a second illustrative embodiment of the invention. In this case, FIGS. 2A and 2B show plan views, FIG. 2C shows an end-on view, and FIG. 2D shows a cross-sectional view cut along the plane indicated in FIG. 2B. Like the box call 100, the box call 200 comprises a pair of end blocks 205 and a pair of opposing sidewalls 210 that define a sound chamber volume 215. And like the box call 100, the box call 200 comprises an upper actuator 220 and a lower actuator 225 pivotally mounted to one of the end blocks. Manually pivoting the upper and lower actuators causes the actuators to scrape against the edges of the opposing sidewalls causing the box call to generate sounds that mimic those produced by wild game.

Nevertheless, the box call 200 differs from the box call 100 in that the former comprises a tuning slat 230 instead of a tuning block 170. In the box call 200, the tuning slat comprises a rectangular, relatively thin hexahedron with a length substantially equal to the distance between the pair of end blocks 205. Two pins (not shown) project from the tuning slat at opposite lengthwise ends and are inserted into holes in the end blocks. These pins hold the tuning slat within the sound chamber volume 215 while allowing the tuning slat to be manually pivoted about a rotational axis 235. A knob 240 at one end of the box call further facilitates the user in pivoting the tuning slat. Angled ends 245 on the tuning slat allow the tuning slat to rest flush against the internal faces of the opposing sidewalls when the tuning slat is oriented as shown in FIG. 2D.

Like translating the tuning block 170, pivoting the tuning slat 230 in this manner changes the properties of the sound chamber volume 215, thereby modifying the sounds produced by the box call 200. Manual tuning of the box call in the field is thereby facilitated.

It should again be emphasized that the above-described embodiments of the invention are intended to be illustrative only. Other embodiments can use different types and arrangements of elements for implementing the described functionality. Rather than using oblique surfaces to capture the tuning block between the pair of opposing sidewalls like those used in the first illustrative embodiment, for example, a rail and groove arrangement or other design may be utilized to achieve similar functionality. In addition, a tuning slat with a substantially different shape from that described above for the second embodiment may be utilized. Additionally or alternatively, the lower and upper actuators may be pivotally mounted to different end blocks rather than the same end block in the manner described above. These numerous alternative embodiments within the scope of the appended claims will be apparent to one skilled in the art.

Moreover, all the features disclosed herein may be replaced by alternative features serving the same, equivalent, or similar purposes, unless expressly stated otherwise. Thus, unless expressly stated otherwise, each feature disclosed is one example only of a generic series of equivalent or similar features.

What is claimed is:

1. An apparatus for generating sounds, the apparatus comprising:
a pair of end blocks, the pair of end blocks disposed at opposite ends of the apparatus;
a pair of opposing sidewalls, the pair of opposing sidewalls attached to the pair of end blocks, and each of the pair of opposing sidewalls having a respective top edge and a respective bottom edge;
an upper actuator, the upper actuator pivotally mounted on one of the pair of end blocks such that pivoting the upper actuator causes it to scrape against the top edges of the pair of opposing sidewalls; and
a lower actuator, the lower actuator pivotally mounted on one of the pair of end blocks such that pivoting the lower actuator causes it to scrape against the bottom edges of the pair of opposing sidewalls.

2. The apparatus of claim 1, wherein the upper and lower actuators are pivotally mounted to the same end block.

3. The apparatus of claim 1, wherein the upper and lower actuators are pivotally mounted to different end blocks.

4. The apparatus of claim 1, further comprising a spring, the spring disposed between the upper actuator and the end block on which the upper actuator is pivotally mounted.

5. The apparatus of claim 1, further comprising a spring, the spring disposed between the lower actuator and the end block on which the lower actuator is pivotally mounted.

6. The apparatus of claim 1, wherein the upper actuator comprises a convex surface that faces the top edges of the pair of opposing sidewalls.

7. The apparatus of claim 1, wherein the lower actuator comprises a convex surface that faces the bottom edges of the pair of opposing sidewalls.

8. The apparatus of claim 1, wherein the top edges of the pair of opposing sidewalls are curved.

9. The apparatus of claim 1, wherein the bottom edges of the pair of opposing sidewalls are curved.

10. The apparatus of claim 1, wherein each of the pair of opposing sidewalls comprises at least two surfaces that meet at an oblique angle.

11. The apparatus of claim 1, further comprising a tuning block, the tuning block captured between the pair of opposing sidewalls and adapted to be manually translatable along a length of the pair of opposing sidewalls.

12. The apparatus of claim 11, wherein manually translating the tuning block modifies the sounds generated by the apparatus.

13. The apparatus of claim 1, further comprising a tuning slat, the tuning slat disposed between the pair of opposing sidewalls and being manually rotatable about a rotational axis that intersects the pair of end blocks.

14. The apparatus of claim 13, wherein manually pivoting the tuning slat modifies the sounds generated by the apparatus.

15. The apparatus of claim 13, wherein the tuning slat is substantially a hexahedron.

16. The apparatus of claim 13, wherein the tuning slat has a length substantially equal to a distance between the pair of end blocks.

17. The apparatus of claim 13, further comprising a knob, the knob operative to pivot the tuning slat.

18. The apparatus of claim 1, wherein the apparatus comprises a plurality of different types of woods.
